(19) United States
(12) Patent Application Publication
(10) Pub. No.: US 2018/0056538 A1
(43) Pub. Date: Mar. 1, 2018

(54) SCORING APPARATUS AND IMAGE FORMING APPARATUS

(71) Applicant: CANON KABUSHIKI KAISHA, Tokyo (JP)

(72) Inventor: Kiyoshi Watanabe, Kofu-shi (JP)

(21) Appl. No.: 15/679,982

(22) Filed: Aug. 17, 2017

(30) Foreign Application Priority Data
Aug. 29, 2016 (JP) 2016-167323

(51) Int. Cl. B26D 3/08; B26D 7/26; B26D 1/00; B65H 37/06

(52) U.S. Cl. CPC B26D 3/085; B26D 7/2614; B26D 2001/006; B65H 37/06; B26D 1/0006

(57) ABSTRACT

A scoring apparatus includes a scoring portion having a first plate member and a pair of second plate members arranged to sandwich the first plate member therebetween. The apparatus is configured to form a score on a sheet by making an end portion of the first plate member and end portions of the pair of second plate members engage with the concave portion. The end portion of the first plate member is positioned closer to the concave portion than the end portions of the pair of second plate members.

### BACKGROUND OF THE INVENTION

### Field of the Invention

The disclosure relates to a scoring apparatus for forming a score on a sheet and an image forming apparatus including the scoring apparatus.

### Description of the Related Art

There is a risk in which an image on a folded portion of a sheet is peeled off when sheet folding processing is executed. In order to reduce peeling of an image, there is provided an apparatus which previously forms a score having a width of 1 mm to 2 mm on a folding portion of a sheet through a scoring unit and folds the sheet along the score formed thereon.

According to a technique discussed in Japanese Patent Application Laid-Open No. 2011-219216, a convex member is formed into a square-shaped projection, whereas a concave portion is formed into a square-shaped groove. Then, the convex member is fit into the square groove. A slight gap which the sheet can enter is provided between the convex member having a square-shaped cross section and the square-shaped groove at respective side faces of the convex member positioned in a width direction thereof and respective side faces of the square-shaped groove. The sheet is pressed into the square-shaped groove by a projection amount of the projection of the convex member, so that a score having a depth corresponding to the projection amount of the projection of the convex member is formed on the sheet.

It is difficult to precisely process the convex member because the convex member is extended long in a sheet width direction. Therefore, the convex member is expensive because of difficulty of the processing. For example, a corner of the convex member may be chamfered or rounded in order to prevent a sheet from being damaged by the convex member having a square-shaped corner. Although quality of the score formed on the sheet depends on precision of the shape of the convex member, it is difficult to precisely process or chamfer the corner of the convex member because the convex member is extended long by a length corresponding to a length of the sheet width.

### SUMMARY OF THE INVENTION

According to an aspect of the disclosure, a scoring apparatus includes a concave portion, and a scoring portion including a first plate member and a pair of second plate members arranged to sandwich the first plate member therebetween, and configured to form a score on a sheet placed between the concave portion and the scoring portion by making an end portion of the first plate member and end portions of the pair of second plate members engage with the concave portion, wherein the scoring portion is configured so that the end portion of the first plate member is positioned closer to the concave portion than the end portions of the pair of second plate members are.

Further features and aspects of the disclosure will become apparent from the following description of numerous example embodiments with reference to the attached drawings.

### BRIEF DESCRIPTION OF THE DRAWINGS

FIG. 1 is a cross-sectional diagram illustrating an image forming apparatus including a scoring apparatus according to an example embodiment of the disclosure.

FIG. 2 is a cross-sectional diagram illustrating the scoring apparatus.

FIG. 3 is a diagram illustrating a scoring unit.

FIG. 4 is a diagram illustrating the scoring unit.

FIG. 5 is a diagram illustrating the scoring unit.

FIG. 6 is a diagram illustrating a sheet on which a score is formed by the scoring apparatus.

FIGS. 7A, 7B, 7C, and 7D are diagrams illustrating a scoring blade.

FIGS. 8A, 8B, and 8C are diagrams illustrating the scoring blade.

FIGS. 9A, 9B, 9C, and 9D are diagrams illustrating scoring blades.

FIG. 10 is a diagram illustrating a scoring blade and a scoring groove.

FIGS. 11A and 11B are diagrams illustrating scoring blades and scoring grooves.

FIG. 12 is a diagram illustrating a scoring blade.

FIG. 13 is a diagram illustrating a scoring blade.

FIG. 14 is a diagram illustrating a scoring blade.

### DESCRIPTION OF THE EMBODIMENTS

Hereinafter, example embodiments, various features and details embodying the disclosure will be described in detail with reference to the appended drawings.

### <Configuration of Printer>

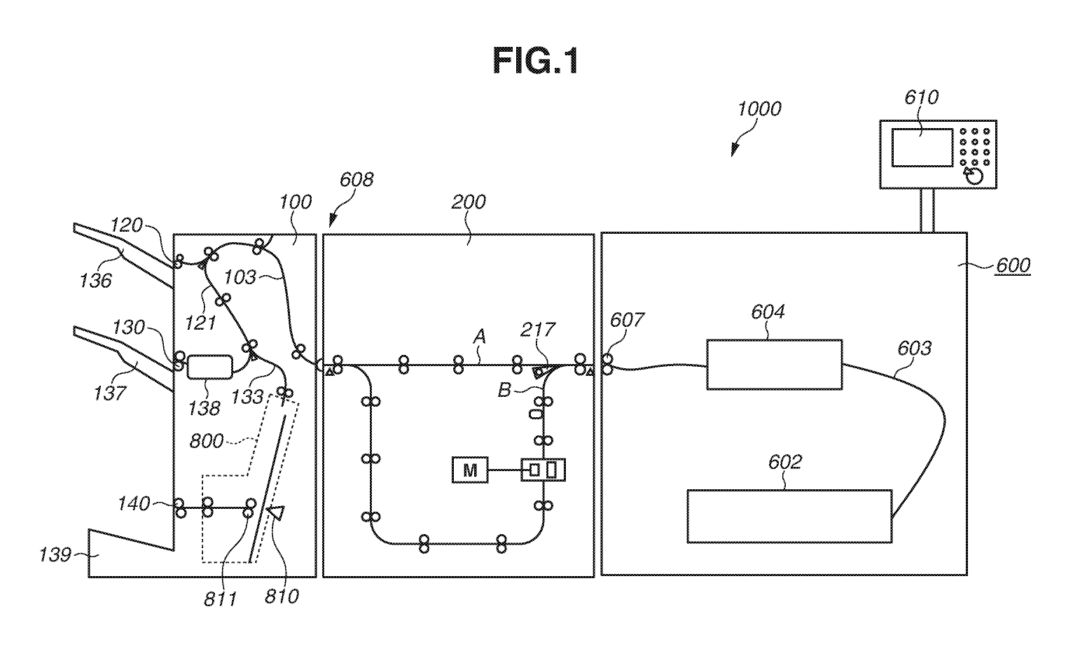

An example configuration of a printer 1000 as an image forming apparatus will be described with reference to FIG. 1. FIG. 1 is a cross-sectional diagram schematically illustrating the printer 1000 according to an example embodiment of the disclosure.

The printer 1000 includes a printer main body 600 that forms an image on a sheet and a sheet processing apparatus 608.

The sheet processing apparatus 608 is arranged so as to be attachable to and detachable from the printer main body 600. The sheet processing apparatus 608 is optionally attached to the printer main body 600 that can be used independently.

Although the present example embodiment will be described with reference to the detachable sheet processing apparatus 608, the sheet processing apparatus 608 and the printer main body 600 may be configured integrally. The sheet processing apparatus 608 is connected to a side portion of the printer main body 600.

The printer main body 600 includes a sheet storing unit 602 for storing sheets and a feeding path 603 for conveying a sheet fed from the sheet storing unit 602. The printer main body 600 further includes an image forming unit 604 for forming an image on a sheet conveyed through the feeding path 603. The sheet on which an image is formed by the image forming unit 604 is conveyed to the sheet processing apparatus 608 from the printer main body 600 by a discharge roller 607.

### <Sheet Processing Apparatus>

The sheet processing apparatus 608 is configured of a scoring apparatus 200 and a finisher 100.

The scoring apparatus 200 that forms a score on a sheet conveyed from the printer main body 600 and conveys the sheet to the finisher 100 will be described below in detail.

The finisher 100 executes post-processing on a sheet conveyed from the scoring apparatus 200.

The finisher 100 includes a conveyance path 103 for receiving and conveying the sheet conveyed from the scoring apparatus 200. The sheet conveyed through the conveyance path 103 is discharged onto an upper stacking tray 136 by an upper discharge roller pair 120.

A conveyance path 121 is branched from the conveyance path 103. The conveyance path 121 guides the sheet to a processing unit 138. The processing unit 138 executes post-processing such as binding processing for binding sheets on the sheet. The sheet passing through the processing unit 138 is discharged onto a lower stacking tray 137 by a discharge roller 130.

A conveyance path 133 is branched from the conveyance path 121. The conveyance path 133 guides the sheet to a saddle stitching processing unit 800. The saddle stitching processing unit 800 executes post-processing such as folding processing for folding the sheet. The saddle stitching processing unit 800 includes a pushing plate 810 for pushing the stored sheet and a folding roller 811 as a folding unit for conveying and folding the sheet pushed by the pushing plate 810. The sheet folded by the saddle stitching processing unit 800 is discharged onto a folded sheet stacking unit 139 by a folded sheet discharge roller pair 140.

### <Scoring Apparatus>

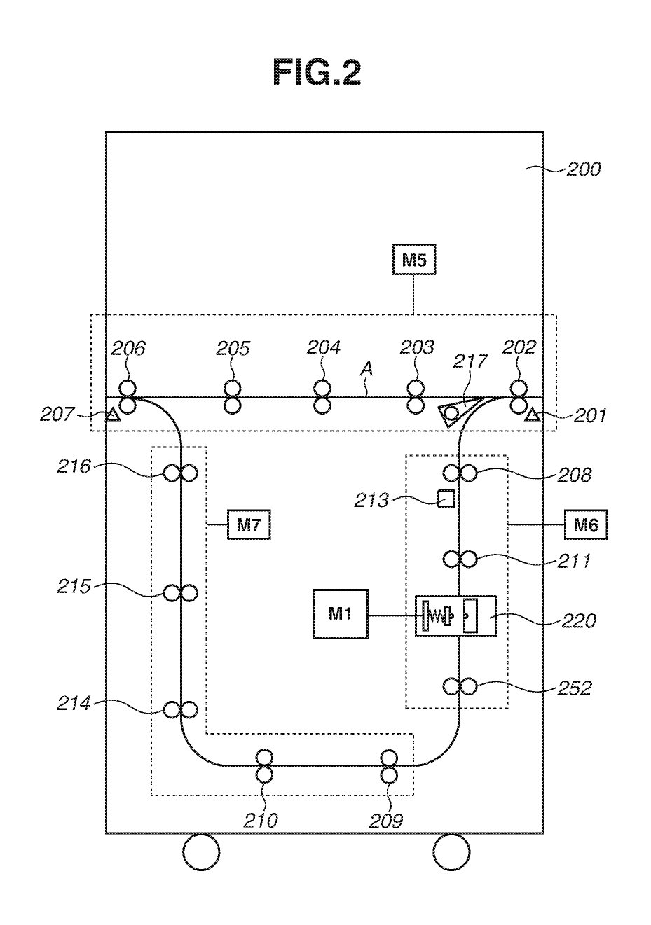

FIG. 2 is a cross-sectional diagram illustrating the scoring apparatus 200. The scoring apparatus 200 sequentially takes in the sheet discharged from the printer main body 600. The scoring apparatus 200 includes a scoring path B for executing scoring processing for forming a score on the sheet and a by-path A for conveying the sheet to the finisher 100 located on the downstream side thereof without executing the scoring processing. The sheet is guided to any one of the by-path A and the scoring path B by a flapper 217 as a swinging guide member.

In addition, the scoring apparatus 200 executes sheet processing according to a user setting input to an operation unit 601 provided on the printer main body 600.

The sheet discharged from the printer main body 600 is conveyed to an inlet roller pair 202 of the scoring apparatus 200. At that time, a handover timing of the sheet is detected by an inlet sensor 201 simultaneously.

When the scoring processing is not executed on the sheet, the sheet is guided to the by-path A by the flapper 217. Then, the sheet is conveyed by conveyance roller pairs 203, 204, and 205 and a discharge roller pair 206 driven by a conveyance motor M5, so as to be conveyed to the finisher 100 on the downstream side.

When the scoring processing is executed on the sheet, the sheet is guided to the scoring path B by the flapper 217. The sheet is conveyed through the scoring path B by conveyance roller pairs 208, 211, and 252 driven by a conveyance motor M6, and an edge of the sheet is detected by a sheet edge detection sensor 213. Then, after the sheet is stopped at a predetermined position in a conveyance direction based on a signal from the sheet edge detection sensor 213, a scoring unit 220 is operated by a driving force received from a driving motor M1 to form a score on the sheet. A score (dent) formed on the sheet by the scoring unit 220 extends in a sheet width direction orthogonal to a sheet conveyance direction. The sheet on which the score is formed is conveyed again, so as to be conveyed to the finisher 100 by conveyance roller pairs 209, 210, 214, 215, and 216 driven by a conveyance motor M7 and a discharge roller pair 206.

In the saddle stitching processing unit 800 of the finisher 100, the sheet is folded in half by the pushing plate 810 and the folding roller 811 by using the score formed by the scoring apparatus 200 as a folding line (folding portion).

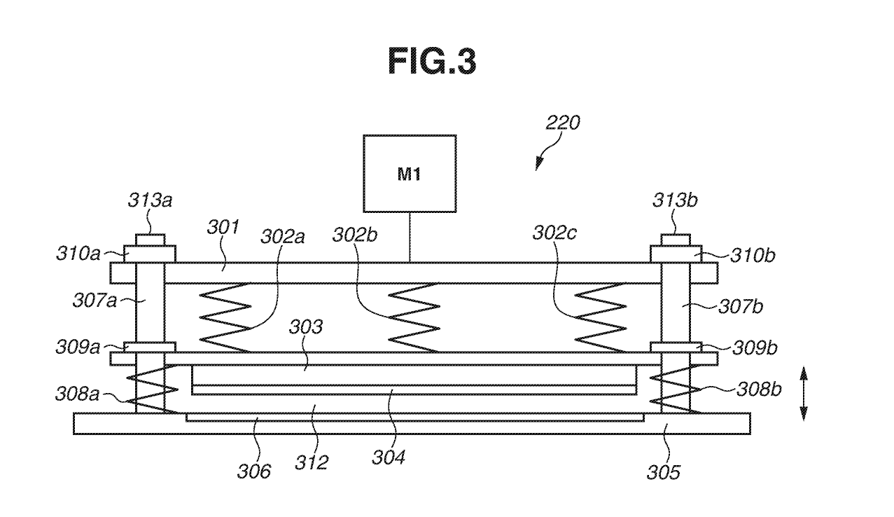

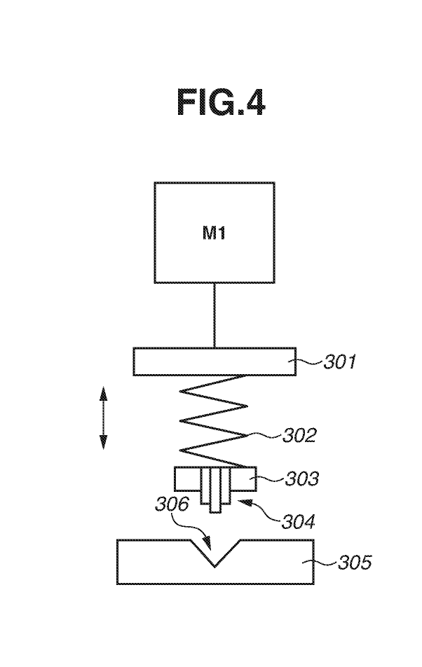

FIG. 3 is a cross-sectional diagram illustrating the scoring unit 220 viewed from a downstream side in the sheet conveyance direction. FIG. 4 is a schematic diagram illustrating the scoring unit 220 viewed from a front face of the scoring apparatus 200.

A die plate 305 includes a scoring groove 306 as a concave portion. Shaft guides 307a and 307b are disposed on the die plate 305 in a standing state. The shaft guides 307a and 307b slidably support a movable plate 301 and a blade holder 303 driven by the driving motor M1. A scoring blade 304 as a convex portion (scoring portion) is arranged on the blade holder 303. Pressure springs 302a, 302b, and 302c are arranged between the movable plate 301 and the blade holder 303.

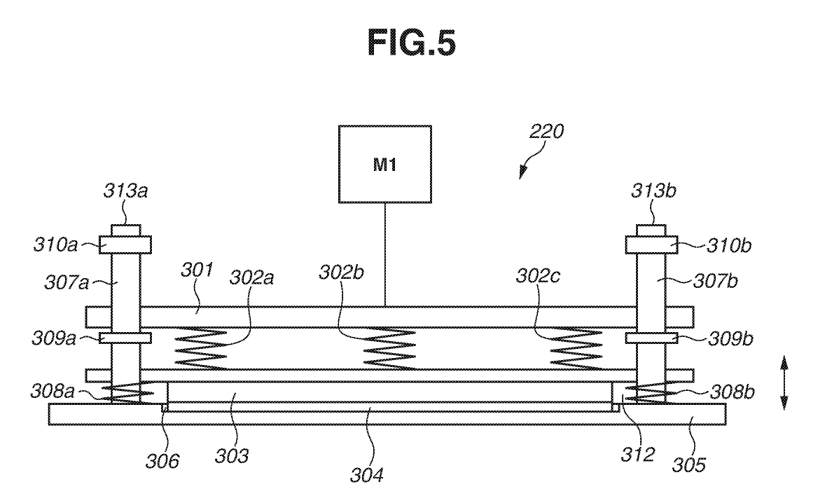

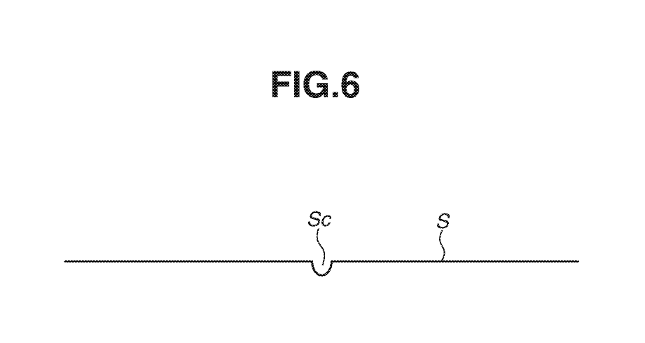

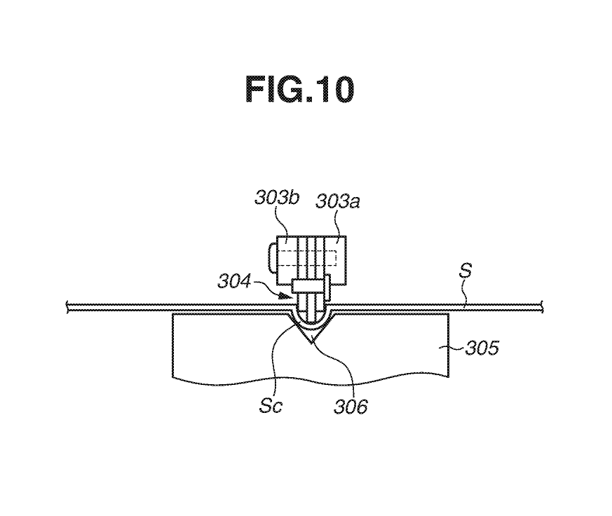

As illustrated in FIG. 5, the movable plate 301 is moved toward the scoring blade 304 by a driving force from the driving motor M1, so that the pressure springs 302a, 302b, and 302c move the blade holder 303 toward the die plate 305. The scoring blade 304 that is held by the blade holder 303 moved toward the die plate 305 approaches and engages with the scoring groove 306 (see FIG. 10). By causing the scoring blade 304 to engage with the scoring groove 306, a score is formed on a sheet S placed between the scoring blade 304 and the scoring groove 306. FIG. 6 is a cross-sectional diagram of the sheet S on which a score Sc is formed when the sheet S is held between the scoring blade 304 and the scoring groove 306. Further, a force is uniformly applied to an entire region in the sheet width direction when the scoring blade 304 engages with the scoring groove 306.

Release springs 308a and 308b illustrated in FIGS. 3 and 5 bring the blade holder 303 and the movable plate 301 that have approached the die plate 305 back to home positions separated from the die plate 305. An upper dead point (home position) of the blade holder 303 is a position where the blade holder 303 abuts on stoppers 309a and 309b. An upper dead point (home position) of the movable plate 301 is a position where the movable plate 301 abuts on stoppers 310a and 310b.

### <Description of Blade>

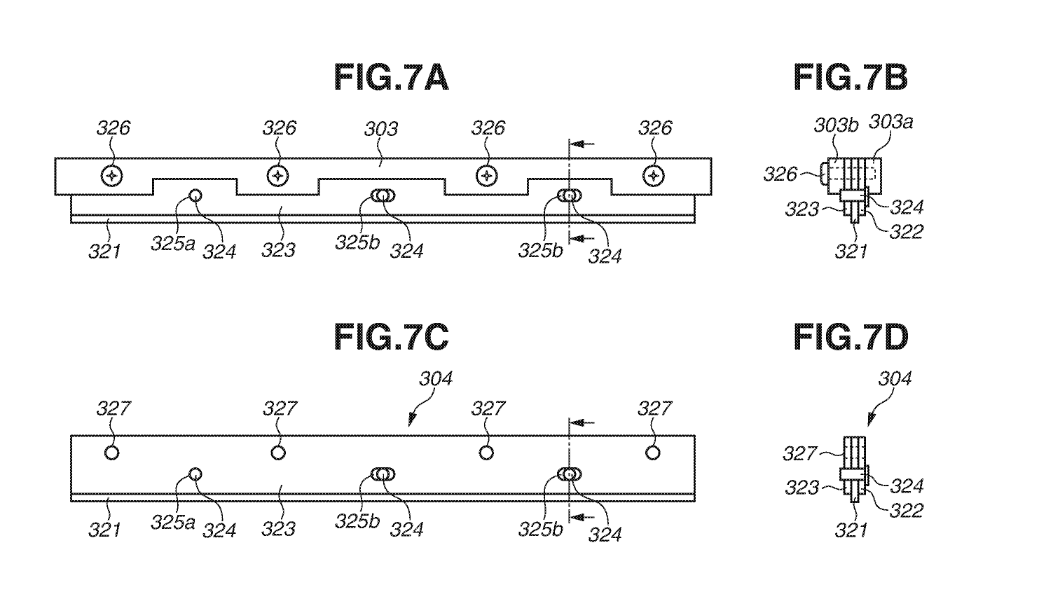

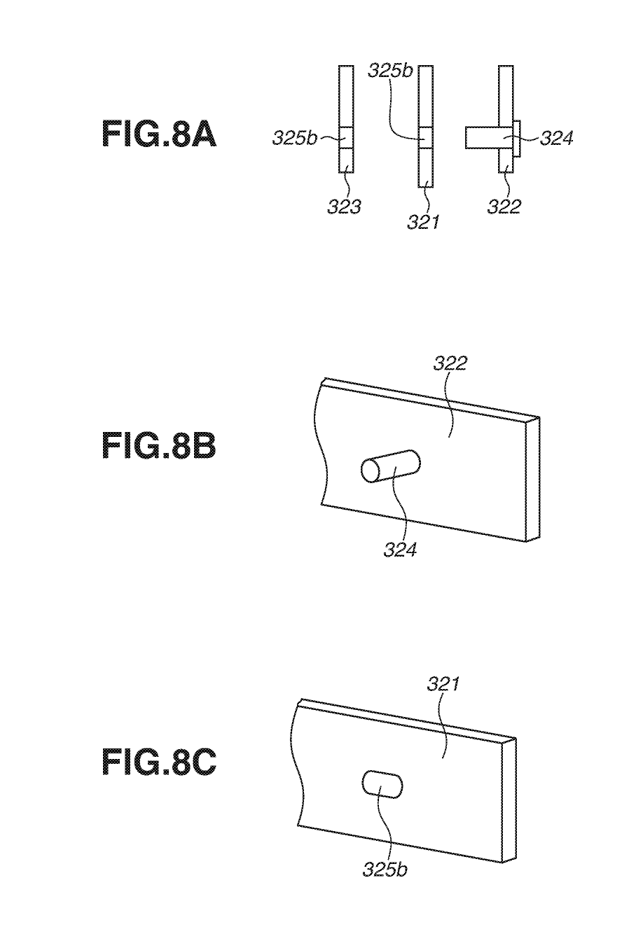

FIGS. 7A, 7B, 7C, and 7D and FIGS. 8A, 8B, and 8C are diagrams illustrating a configuration of the scoring blade 304. FIGS. 7A and 7B are diagrams illustrating a state where the scoring blade 304 is held by blade holders 303a and 303b. FIGS. 7C and 7D are diagrams illustrating a state where the scoring blade 304 is not held by the blade holders 303a and 303b.

The scoring blade 304 is configured of a first blade member 321 and a pair of second blade members 322 and 323 arranged to hold therebetween the first blade 321 on both sides. FIG. 8A is a diagram illustrating the shapes of the first blade member 321, and the second blade members 322 and 323 as individual components. The first blade member 321 and the pair of second blade members 322 and 323 are metallic plate members. The thicknesses of the first blade member 321 and each of the pair of second blade members 322 and 323 are equal to each other.

Three positioning pins 324 are arranged on one blade member 322 of the pair of second blade members. The three positioning pins 324 are caulked with and fixed to the blade member 322. A positioning circular hole 325a and two positioning elongate holes 325b are arranged on each of the first blade member 321 and another blade member 323 of the pair of second blade members. The positioning pins 324 are respectively inserted to the positioning circular hole 325a and the positioning elongate holes 325b, so that the first blade member 321 and the blade member 323 of the pair of second blade members are positioned with respect to the blade member 322 of the pair of the second blade members. An end portion of the first blade member 321 held between the pair of second blade members 322 and 323 (i.e., an end portion on a side of the scoring groove 306) is projected to the side of the scoring groove 306 with respect to the end portions of the pair of second blade members 322 and 323. In other words, the end portion of the first blade member 321 is positioned closer to the scoring groove 306 than the end portions of the pair of second blade members 322 and 323 is. Further, positions of the end portions of the pair of second blade members 322 and 323 coincide with each other in a direction toward the concave portion. A convex shape is formed by the end portions of the first blade member 321 and the pair of second blade members 322 and 323.

The scoring blade 304 configured of three blade members, i.e., the first blade member 321 and the pair of second blade members 322 and 323, is held between the blade holders 303a and 303b. Then, the scoring blade 304 is fixed by screws 326 inserted into screw holes 327 while being held between the blade holders 303a and 303b, to be attached to the blade holders 303a and 303b (scoring unit 220).

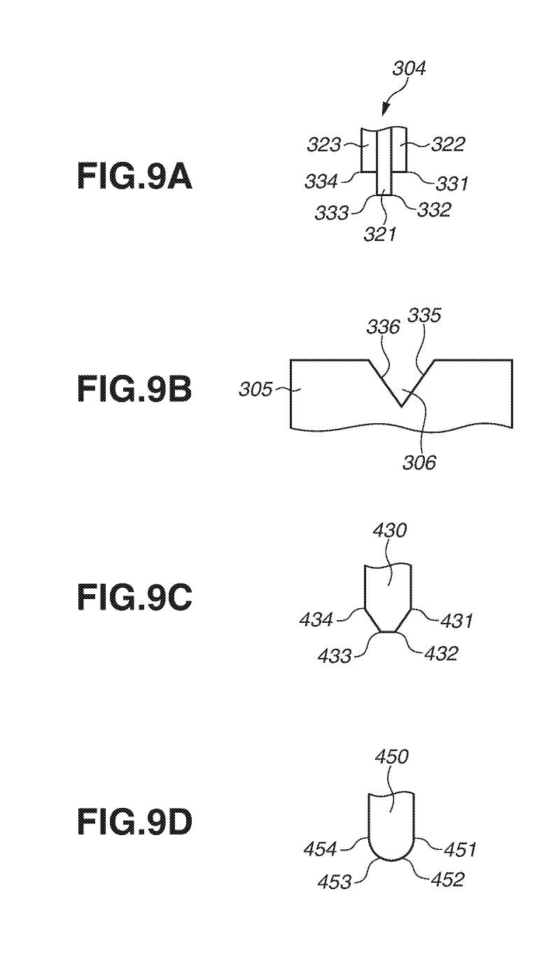

FIGS. 9A, 9B, 9C, and 9D are diagrams illustrating enlarged views of convex shapes of leading end portions of scoring blades and a concave-shaped scoring groove 306 provided on the die plate 305.

FIG. 9A is a diagram illustrating the scoring blade 304 of the present example embodiment. FIG. 9B is a diagram illustrating the scoring groove 306 of the present example embodiment. FIG. 9C is a diagram illustrating a blade member 430 having inclined faces that correspond to inclined faces 335 and 336 of the scoring groove 306. FIG. 9D is a diagram illustrating a blade member 450 having an R-shaped face that corresponds to the inclined faces 335 and 336 of the scoring groove 306.

The blade members 321 and 322 in FIG. 9A are arranged to bring corner portions 331 and 332 of the blade members 321 and 322 into contact with the inclined face 335 of the scoring groove 306 in FIG. 9B. The respective blade members 321 and 323 in FIG. 9A are arranged to bring corner portions 333 and 334 of the blade members 321 and 323 into contact with the inclined face 336 of the scoring groove 306 in FIG. 9B. The edges (corner portions 331, 332, 333, and 334) of the respective blade members 321, 322, and 323 fit into the scoring groove 306, so as to be in contact with the sheet S (see FIG. 10). A width and a depth of the score Sc formed on the sheet S are determined by the four corner portions 331, 332, 333, and 334 (see FIG. 10).

The four corner portions 331, 332, 333, and 334 of the scoring blade 304 in FIG. 9A correspond to corner portions 431, 432, 433, and 434 as the edges of the inclined faces of the scoring blade 430 in FIG. 9C. Further, the four corner portions 331, 332, 333, and 334 of the scoring blade 304 in FIG. 9A correspond to corner portions 451, 452, 453, and 454 as the edges of the R-shaped face of the scoring blade 450 in FIG. 9D.

In the scoring blade 304 of the present example embodiment, precision of the shape of the end portion of the scoring blade 304 can be secured by simply executing sheet-metal processing while precisely assuring a distance from the end portion of each of the blade members 321, 322, and 323 to the positioning portion. In the present example embodiment, the positioning portion of the blade members 321, 322, and 323 correspond to a portion of the positioning circular hole 235a and the positioning pin 324 fitting into the positioning circular hole 235a. Further, the precision relating to the shape of the end portion of the scoring blade 304 corresponds to the precision of relative positions of the four corner portions 331, 332, 333, and 334 of the end portions of the scoring blade 304.

The scoring blade 304 in the present example embodiment can be manufactured at a cost lower than that of the scoring blade 430 in FIG. 9C or the scoring blade 450 in FIG. 9D which have to be precisely processed by a milling machine or a grinding machine. In other words, in order to uniformly form a score having a desired shape over an entire sheet width region, the scoring blade has to be manufactured so as to make the edge of the scoring blade reliably fit into the scoring groove over the entire sheet width region. In the configuration illustrated in FIG. 9C or 9D, in order to manufacture the scoring blade which reliably fits into the scoring groove, an edge of the scoring blade has to be precisely processed over an enter region in the lengthwise direction thereof by using the milling machine or the grinding machine. In other words, in the configuration illustrated in FIG. 9C or 9D, for example, a long thin plate member that corresponds to a full width of the sheet (e.g., a length of 300 mm or more) and a score width (e.g., approximately 1 mm) has to be processed precisely. Therefore, the configuration illustrated in FIG. 9C or 9D is costly because of difficulties of the processing. In the present example embodiment, the scoring blade 304 capable of reliably forming a score can be manufactured by simply executing sheet-metal processing while precisely assuring a distance from the end portion of each of the blade members 321, 322, and 323 to the positioning portion. Accordingly, the present example embodiment is less costly compared with the embodiment in FIG. 9C or 9D.

Further, an example embodiment in which the score is formed on the sheet by moving the scoring blade 304 by the driving motor M1 has been described. However, the die plate 305 having the scoring groove 306 may be moved with respect to the scoring blade 304 through a driving force from a driving source such as a motor while fixing the scoring blade 304.

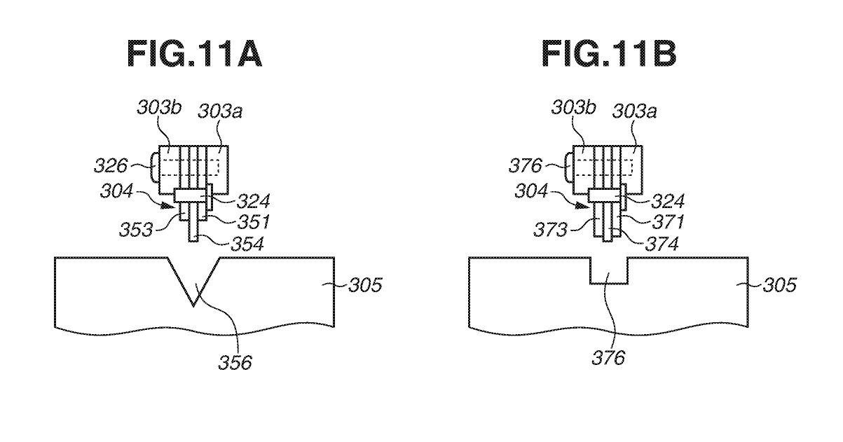

With respect to the scoring blade according to the present example embodiment manufactured by combining a plurality of plate-shape blade members, a distance from the end portion of the plate member to the positioning portion may be determined according to the convex shape of the scoring groove. For example, as illustrated in FIG. 11A, when the concave shape (concave portion) of the scoring groove is formed into a deep groove 356, a difference between the end portions of the first blade member 354 and the second blade members 351 and 353 may be increased.

Further, in the above-described example embodiment, the scoring groove having a V-shaped cross section has been described. However, for example, as illustrated in FIG. 11B, the scoring groove may be a groove (convex portion) 376 having a rectangular-shaped cross section. For example, as illustrated in FIG. 11B, when the concave shape 376 has a rectangular-shaped cross section, a difference between the end portion of the first blade member 374 and the end portions of the second blade members 371 and 373 may be decreased.

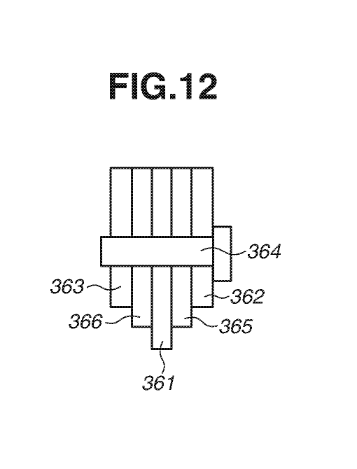

Further, in the above-described example embodiment, although three blade members are combined, as illustrated in FIG. 12, five blade members 361, 362, 363, 365, and 366 may be combined. In this case, positioning of the blade members 361, 362, 363, 365, and 366 is executed by using a positioning pin 364 provided on the blade member 362 arranged at an outermost position. Furthermore, in the above-described example embodiment, although three blade members are combined, the scoring blade may be configured of two blade members, end portions of which are shifted from each other.

Further, in the above-described example embodiment, blade members are positioned by using a positioning pin caulked with a blade member and a positioning hole provided on another blade member, to be fastened with a screw. However, a positioning boss may be provided on one blade member, and a convex portion or a hole which the boss fits into may be provided on another blade member. Instead of fixing the blade members with a screw, the blade members may be fixed by welding.

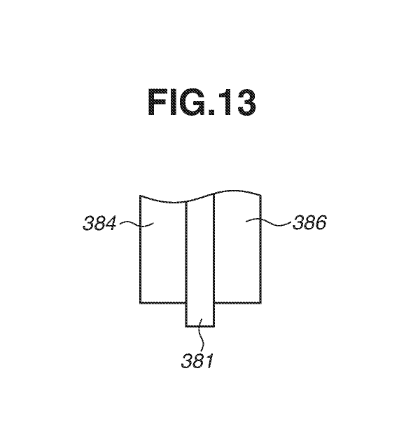

Further, in the above-described example embodiment, thicknesses of the first blade member and the second blade members arranged to sandwich the first blade member therebetween are equal to each other. However, blade members having different thicknesses may be combined. For example, as illustrated in FIG. 13, a pair of second blade members 384 and 386 that are thicker than the first blade member 381 arranged at the center may be used. In this case, in order to form a score having a shallow depth and a large width on a sheet, the scoring blade can be configured of three plate members instead of five plate members having the same thickness. In addition, the thicknesses of the pair of second blade members 384 and 386 are equal to each other.

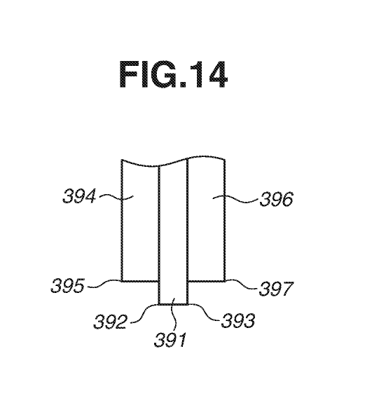

FIG. 14 is a diagram illustrating a variation example of the scoring blade 304 configured of blade members made of different materials. Metallic plate members are used as second blade members 394 and 396 arranged on both sides. Then, a rubber material having high hardness is used as a first blade member 391 arranged at the center. In this case, the sheet is firmly pressed by corner portions 395 and 397 of the metallic blade members 394 and 396 while being moderately pressed by corner portion 392 and 393 of the blade member 391 at the center. Accordingly, it is possible to form a score having a curvilinear shape curved more smoothly at the center than the both corners.

While the disclosure has been described with reference to example embodiments, it is to be understood that the invention is not limited to the disclosed example embodiments. The scope of the following claims is to be accorded the broadest interpretation so as to encompass all such modifications and equivalent structures and functions.

This application claims the benefit of Japanese Patent Application No. 2016-167323, filed Aug. 29, 2016, which is hereby incorporated by reference herein in its entirety.

What is claimed is:

1. A scoring apparatus comprising:
a concave portion; and
a scoring portion including a first plate member and a pair of second plate members arranged to sandwich the first plate member therebetween, and configured to form a score on a sheet placed between the concave portion and the scoring portion by making an end portion of the first plate member and end portions of the pair of second plate members engage with the concave portion,
wherein the scoring portion is configured so that the end portion of the first plate member is positioned closer to the concave portion than the end portions of the pair of second plate members.

2. The scoring apparatus according to claim 1, wherein a position of an end portion of one of the pair of second plate members and a position of an end portion of another of the pair of second plate members coincide with each other in a direction heading toward the concave portion.

3. The scoring apparatus according to claim 1, wherein a thickness of one of the pair of second plate members and a thickness of another of the pair of second plate members are equal to each other.

4. The scoring apparatus according to claim 1, wherein a thickness of the first plate member and a thickness of each of the pair of second plate members are equal to each other.

5. The scoring apparatus according to claim 1, wherein a thickness of the first plate member and a thickness of each of the pair of second plate members are different from each other.

6. The scoring apparatus according to claim 1,
wherein the scoring portion further includes a pair of third plate members arranged to sandwich the pair of second plate members therebetween, end portions of which contact a sheet, and
wherein the scoring portion is configured so that the end portions of the pair of second plate members are positioned closer to the concave portion than end portions of the pair of third plate members are.

7. A scoring apparatus comprising:
a concave portion; and
a scoring portion configured to form a score on a sheet placed between the concave portion and the scoring portion,
wherein the scoring portion includes:
a first plate member an end portion of which is configured to contact the sheet; and
a second plate member an end portion of which is configured to contact the sheet,
wherein the scoring portion forms a score on the sheet placed between the concave portion and the scoring portion by making an end portion of the first plate member and an end portion of the second plate member engage with the concave portion, and
wherein positions of the end portions of the first plate member and the second plate member are shifted from each other.

8. An image forming apparatus comprising:
an image forming unit configured to form an image on a sheet;
a scoring apparatus configured to form a score on a sheet on which an image is formed by the image forming unit, the scoring apparatus comprising:
a concave portion; and
a scoring portion including a first plate member and a pair of second plate members arranged to sandwich the first plate member therebetween, and configured to form a score on a sheet placed between the concave portion and the scoring portion by making an end portion of the first plate member and end portions of the pair of second plate members engage with the concave portion,
wherein the scoring portion is configured so that the end portion of the first plate member is positioned closer to the concave portion than the end portions of the pair of second plate members; and
a folding unit configured to fold a sheet at a position of a score formed by the scoring apparatus.
